(19) United States
(12) Patent Application Publication
(10) Pub. No.: US 2005/0135907 A1
(43) Pub. Date: Jun. 23, 2005

(54) Medical lift and transport system, method and apparatus

(76) Inventors: James P. Romano, Syracuse, NY (US); Americo Santillo, Auburn, NY (US)

Correspondence Address: BOND, SCHOENECK & KING, PLLC, ONE LINCOLN CENTER, SYRACUSE, NY, 13202-1355, US

(21) Appl. No.: 10/997,273

(22) Filed: Nov. 24, 2004

Related U.S. Application Data
(60) Provisional application No. 60/524,512, filed on Nov. 24, 2003.

(51) Int. Cl. B65F 9/00

(52) U.S. Cl. 414/401

(57) ABSTRACT

Medical transport system for lifting and moving heavyweight patients, said system comprising an articulated pallet (i.e. bed) which stays with the patient for the duration of treatment and a Movable, variable height lifting mechanism for receiving or depositing said pallet from or to the ground, a bed or an operating table. Said system further comprising means to easily move the lifted pallet from one place to another.

### CROSS-REFERENCE TO RELATED APPLICATION

The present application claims priority to U.S. Provisional Patent Application Ser. No. 60/524,512, filed Nov. 24, 2003.

### FIELD OF THE INVENTION

The invention relates generally to a method and apparatus for lifting and moving patients, and more particularly, for the lifting and moving of heavy or obese patients comfortably in a hospital or nursing home setting.

### BACKGROUND OF THE INVENTION

Since the dawn of medical practice, the treatment of the patient has been the principal focus of caregivers. Very often this care necessitates the lifting and moving of these injured, elderly, or otherwise infirm patients. Problems associated with moving and lifting are exacerbated when there is only one caregiver and/or when the patient is unusually heavy or large. Several schemes have been used over the years to address these issues, such schemes ranging from litters and stretchers to automated devices of various and sundry designs. The principal problem with these devices is that a person or persons must, at various times, physically lift or move the patient using bodily strength. As is well pointed out in the prior art, the potential for back injury, or other injury, to the caregiver is omnipresent and becomes more severe as the size and weight of the patient increases. Thus, a medical transport system that minimizes or precludes the need for the caregiver to lift and carry a heavy patient during the course of treatment would be beneficial to both.

### DESCRIPTION OF PRIOR ART

Patent archives are replete with descriptions of devices intended for lifting heavy objects. Mechanisms for lifting heavy pipes (i.e. Alexander et. al. U.S. Pat. No. 6,568,731) and other inanimate objects are plentiful, but do not address the unique needs of lifting human beings. Descriptions of forklifts and hand trucks detail the methods for lifting and moving palletized loads. (I.e. McCormick U.S. Pat. No. 4,236,862 McCabe, et al. U.S. Pat. No. 4,655,039) although addressing the specifics of lifting a heavy palletized load, they also do not address the unique needs of lifting human beings. Those patents relating to lifting people (as opposed to lifting people in the sense of an elevator, for example), generally relate to the lifting of wheelchair bound individuals for the purpose of traversing stairs or entering and exiting vehicles of various natures. Sardonico U.S. Pat. No. 6,558,106 describes such a device and references several other patents of this ilk but assumes the lifting of individual and chair from one level to another usually under the control of the individual him, or her, self. Becklund U.S. Pat. No. 5,829,948 describes a lifting mechanism with very diverse capabilities. While it might be argued that the Becklund device could be used for the lifting of invalid patients, the patent and its referenced descriptions clearly indicate the utility for lifting and moving heavy, but inanimate objects. Again, it does not address the needs of the human being. Fridman et al. U.S. Pat. No. 5,148,557, and associated references, on the other hand, clearly describes a mechanism dedicated to the lifting and moving of human beings. The Fridman approach uses a cart like device requiring the patient to be first put into the cart and then bent over and strapped in. It still requires lifting the patient. Devices using slings and cables (similar in nature to an automobile engine hoist) are presently in use, and are certainly an advance in the direction of reducing caregiver injury and improving patient comfort in the process. Again, the patient still needs to be moved and lifted in order to use the device. However effective, they are but one approach related to, but not interfering with the present invention (which is more similar in nature to a forklift designed specifically with the needs of disabled human beings in mind). The present invention also does not require that the patient be moved from his bed in order to be transported as do each of the prior patents. Even the Scheuts patent U.S. Pat. No. 2,187,283 requires the patient to enter and exit the device at each use. Invalid individuals need to be physically assisted, whereas the present invention precludes that necessity.

### SUMMARY OF THE INVENTION

In this application, the words “pallet” and “bed” are considered synonymous. In general, the present invention consists of a pallet (i.e. bed) upon which the patient is placed. Said pallet that replaces the hospital bed mattress can be placed upon a hospital bed (with or without a conventional mattress). Said pallet consists of either a solid or webbed surface stretched over a structural framework in a manner similar to a camping cot. Said surface is preferably a visco-elastic gel coated netting which is waterproof, washable and comfortable for the patient. Said surface precludes the necessity of sheets or other bedding between the patient and the pallet. Thus, the patient need not be disturbed to change sheets. Sufficient room is provided beneath said surface to place a sheet or other bedding material for sanitary protection of bedding below. Patient bathing and cleaning can be accomplished without having to lift the patient from the bedding. The cleaning of the pallet can be easily accomplished from below or by having the patient turned to one side rather than having to be lifted from the sheets. Since the pallet is a waterproof surface, whatever little excess water remains after bathing, can be easily removed. Said pallet is further furnished with side extensions that can be folded up to implement side guards when needed. Further, when not deployed, said guardrails can be locked into a flat position which increases the width of the pallet, offering a larger bed area for the larger patient. Further said pallet is operatively hinged near the head of the pallet to coincide with the point of movement of a standard hospital bed, allowing the head of the pallet to move up and down with the hospital bed. Ratchet mechanisms, detents, or other incremental locking mechanisms can be used to keep the folding portions of the pallet in any given position as desired.

The framework of the pallet is constructed to operatively allow the above said surface to be attached, leaving ample room between the surface and the lifting tracks below. The space between the upper and lower portions of the framework (i.e. the surface above and the lifting tracks below) is provided to allow sufficient room for the surface to stretch without bottoming. Optionally, an inflatable cushion below the surface (but above the lift tracks) could be employed to increase patient comfort. Said inflatable cushion is easily removed and replaced as needed without disturbing the patient offering greater ease and personal safety to the caregiver. Further, said framework is designed with sufficient strength and rigidity to allow it to be lifted by specially designed lift points on the lower sides of the pallet, said lift points described hereafter. Said framework is also fitted with a set of locking roller tracks operatively fastened to it at one or more places. Said tracks are used not only as receptacles for the lifting units' rail forks, but also as guides to position the pallet over the lift and for adding structural strength to the pallet. In the preferred embodiment, and as a safety factor, the pallets' guardrails must be deployed before the lift vehicle can engage the pallet. Mechanical means connected to said side rails are envisioned here whose purpose is to block the entrance to the tracks until the side rails are lifted. By law, the side rails of a hospital bed must be upright before a patient can be moved. When the side rails are moved to the upright position, the mechanical are lifted or otherwise removed from the entry point of said tracks to allow the lift forks to enter the tracks. Another object of this invention is to provide the ability for two pallets to temporarily connect together for the purpose of transferring a patient from one to the other should the need occur. From a practical perspective, the pallet may need to be replaced or repaired from time to time and by connecting two together, will allow the patient to be rolled from one to the other safely and comfortably without the need for caregivers to manually lift the individual.

The lifting mechanism is preferably an electric battery powered motorized hand truck capable of lifting and moving loads of up to one ton. Lift trucks are well known in the art and many patents have been issued for their design. U.S. Pat. No. 3,998,346 Gibson, et al. and U.S. Pat. No. 5,685,555 McCormick et al. for example, describe such vehicles. With the modifications claimed in the present patent, such lifts could be made suitable for the present application. More simple and fundamental designs are also possible and practical. The present invention describes a lift device with a set of rails, (one on each side of the lift) which act in a similar fashion to the forks on a lift truck. Said rails extend forward of the lift device in their quiescent position only far enough to engage the tracks in the pallet frame. The short protrusion length allows for easier maneuvering in a hospital or operating room. The rails (which are connected to the lift mechanism) are also each able to move laterally off their central axis by several centimeters in either direction operatively spring loaded to return to center. By doing so, compensation for any minor misalignment of the lift and pallet engagement is achieved. As will be seen, said rails can also be extended and retracted by the operator as needed. Once the lift rails engage the pallet tracks, detent latching or locking mechanisms on the end of the rails engage slots in the pallet track and prevent it from falling off the rails. At this point, the rails are allowed to extend into the pallet tracks to allow the lift to bear the weight and to minimize torsional stresses on the pallet frame. It should be noted here (and will be explained in detail shortly) that a set of stabilizing wheels located at the base of the lift are extended prior to engaging the pallet and are retracted once the pallet is centered over the lift. These stabilizing wheels provide a stable platform to prevent tipping of the lift as the pallet is raised. The pallet is then lifted from its resting place until it is above the top of the lift device. The pallet is then rolled along the lift rail(s)until the detents reach the opposite end of the track slots. Roller devices built into the fork rails facilitate the movement of the pallet. Many options for extending and retracting the rail forks exist. These include but are not limited to manual extension and retraction, motor control using belts, gears or pulleys or electronic stepper motors. Once stably connected, the rails with pallet are retracted and stably positioned (i.e. centered) over the top of the lift. As the pallet is centered, a second set of latches on the opposite side of the rails is engaged, preventing the pallet from sliding off either end of the rail. In this manner, the pallet can be moved on or off either side of the lift. The lift truck then moves the pallet to its desired location. The centering of the pallet over the lift offers maximum stability while moving, and more practically allows the lift truck and pallet to enter and exit narrow openings such as hospital doorways. Presently, fork lifts and hand trucks do not have this capability. To remove the pallet, the lift truck is moved into position. The pallet is lifted to its desired height, and one set of detents is released. The pallet is then moved along the lift rails to the extended position over the bed or operating table. The lift is lowered, the second set of detents is released, and the rails are detached from the lift. Mechanical or electrical means can be employed to extend or retract the detent latches when attachment or removal of the pallet from the lift is needed. The lift mechanism is further operatively fitted with sufficient counter weights to prevent tipping while the pallet is being lifted. The lift unit's batteries generally provide sufficient counter weight, but can be augmented with extra ballast as needed. Another object of this invention is to provide an optional bi directional winch to pull the pallet along the rails once lifted into position. This is desirable only when the lift unit is constructed to be manually operated and not electronically controlled.

Some safety considerations are necessary to prevent the lifting or moving of the pallet before it has been adequately connected and secured to the lift rails. There is a plethora of means to that end. However, in it's simplest form, the lift mechanisms' controller (which is integrally built into, or operatively connected to the lift device) must know when the pallet is adequately connected. In the embodiment cited as an example in this application, the lift rail detent latches need to be fully engaged before the system can be considered secure. Switches or other sensor means connected to said latches operatively feed information to the lifts' control system. One skilled in the art will recognize that mechanical, optical, acoustic, or magnetic sensors can perform this function. If the latches are electrically implemented, signals derived from said sensors, can tell the lifts' controller when to engage and disengage said latches. Not until the controller detects the correct security parameters can it begin to lift or move. Naturally, programmed considerations for moving the lift from place to place without a load are included as a matter of course. A set of operator controls is included to effect vertical movement of the rails, as well as controls for “driving” (moving) the lift from place to place. FIG. 7 shows a practical block diagram of such a control system. The control panel can be an integral part of the lift or alternatively, a separate controller operatively connected to the lift by a cable. Further, RF, acoustic, or optical wireless means can be employed as remote controls. In the example cited, simple wired controls are demonstrated for simplicity and clarity.

It should be understood that any number of lifting schemes are possible. Hydraulic rams, scissor jack arrangements, cam operators, pneumatic balloons and other devices well known in the art can be used. However for a specific example in this application, the screw jack method, which is well in the public domain, is used and explained.

The novelty of this system lies in its ability to facilitate the lifting and moving of heavyweight individuals with no risk of strain to the caregiver and with maximum comfort to the patient.

### BRIEF DESCRIPTION OF THE DRAWINGS

Drawing 1. Perspective view of the pallet and lift

Drawing 2. Pre-engagement of pallet and lift

2A. Rails shown retracted

2B. Rails shown extended

Drawing 3. Track, rail, and detent scheme

3A. Depiction of fork and mating pallet rail

3B. Engagement sequence of rail and track

3C. Depiction of one possible rail extension and retraction means

Drawing 4. Operating sequence of the system

4a. Pre-engagement of lift and pallet

4b. Stabilizing wheels extended

4c. Rail forks extended into mating pallet track

4d. Pallet raised to a height above the lift

4e. Pallet centered over the lift

Drawing 5. One embodiment of the mechanism used to engage, lift, and move the pallet.

Drawing 6. Articulated pallet

Drawing 7. Control system block diagram

### DESCRIPTION OF A PREFERRED EMBODIMENT

Referring to the drawings:

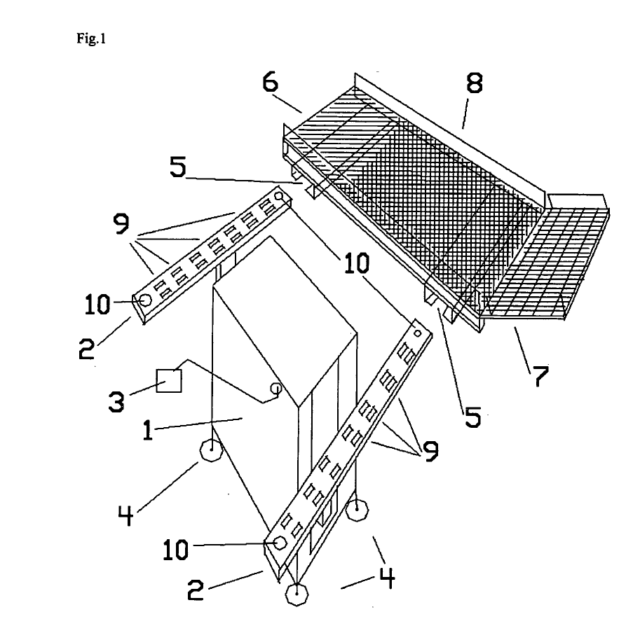

FIG. 1 is a perspective view of the lift and pallet, showing the basic elements of both and the general scheme of how they work together. Lift truck (1) contains a set of rails (i.e. forks) (2) which engage tracks (5) built into pallet (6). Lift truck (1) is preferably a low voltage battery powered vehicle capable of being maneuvered under electro motive power and controlled by control panel (3). Through the implementation of 4 wheel steering (4), said lift truck is capable of forward, backward and sideways movement under control of the user. During normal operation, said lift truck is maneuvered into position such that rail forks (2) line up with pallet tracks (5). The lift truck is moved ahead until the rails enter the tracks.

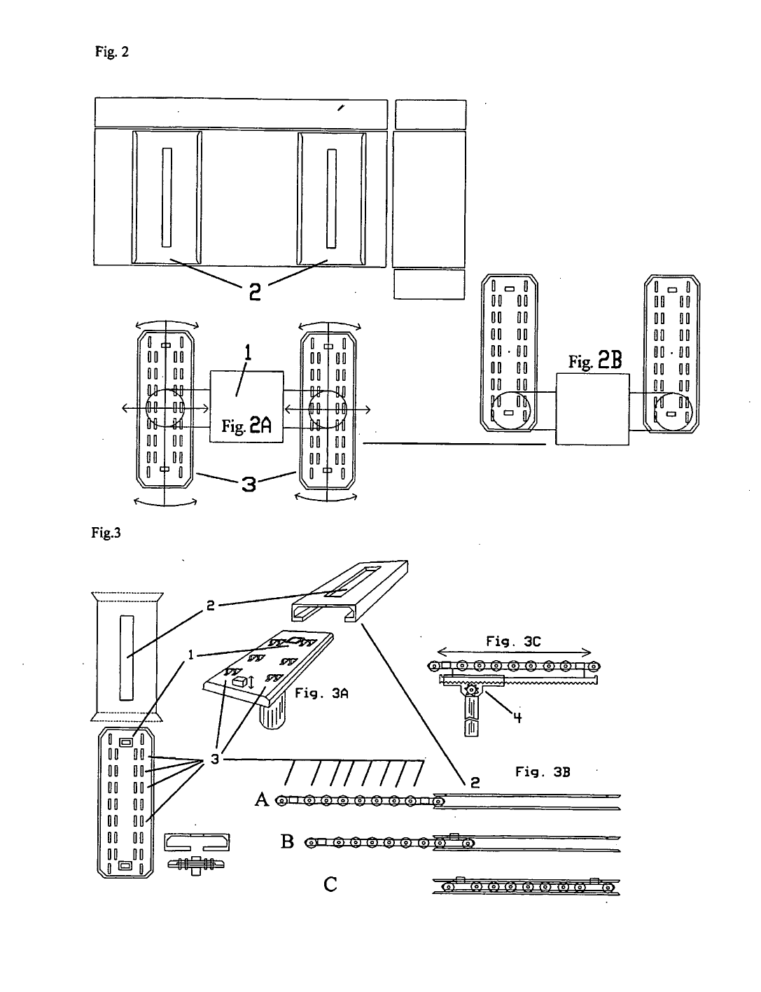

FIG. 2. shows a top view of the lift truck (1) about to engage the pallet tracks. With a few centimeters of travel left and right of their central axis and a few degrees of rotational capability about their central axis, the rails (3) are able to self-correct for any slight misalignment between the lift and the pallet. Tapered rail ends (4) assist in initial alignment. Said rails are preferably spring loaded to return to a straight and centered position when not in actual use.

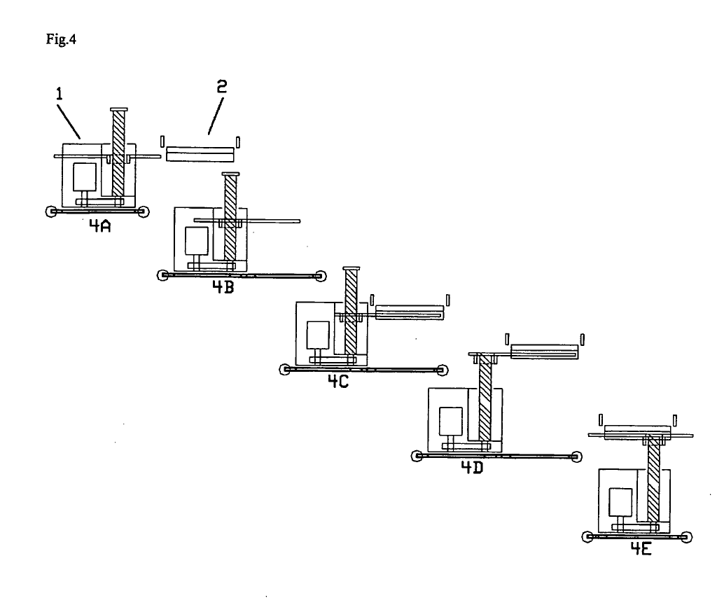

FIG. 3. Once the rail forks engage the pallet tracks and are extended, detent latches (1) on the end of the rails snap into place in the track slots (2), preventing the pallet from sliding off the rail. Said latches can be of the mechanical type or of the electrically actuated type. FIG. 3 shows said latches (1) atop the rails even though they can be along the sides or in both locations. Their principal purpose is, again to prevent the pallet from falling off the rail. Once the lift and pallet are engaged, the pallet is ready to be lifted.

FIG. 3B depicts the typical sequence of railtrack engagement. First, the rail enters the track but the latches are not yet engaged. Next, the rail moves farther into the track until latch (1) is far enough in to engage the track slot (3). This is the lift position. At this point, the pallet and the rail are solidly connected and the pallet effectively becomes an extension of the rail fork. The pallet is then lifted above the lift truck body and moved along the rails until the second latch (2) is also far enough in to engage the rail slot (3). By properly designing the slot length and latch spacing, the pallet will engage both latches and have little or no available lateral movement remaining.

FIG. 4 schematically depicts the typical sequence of events involved in engaging and moving the pallet (including optional patient, of course). Side view is shown for clarity. First, (4A) the lift (1) approaches the pallet (2). Next, (4b) Stabilizing wheels at the base of the lift are extended to provide a stable platform. (4C) Rail forks are extended into the pallet tracks and latched in place. (4D). The pallet is then lifted to a height slightly above the top of the lift body so that the pallet can be retracted to a position over the top of the lift mechanism (4E). Once lifted, the pallet can be moved along with the rails to a position centered over the lift. Rollers or other bearing devices (FIG. 3 #3) on each rail facilitate the movement of the pallet along the rails. Although the rails are operatively equipped with suitable bearings, which would make the movement of the pallet along the rails a non strenuous task, the system could optionally be fitted with a winch and pulley system which would pull the pallet along the rails in either direction. Once the pallet is centered over the lift, the detent latches on the opposite end of the rail forks would be deployed into the slot in the pallet rendering the pallet immovable in either direction along the rails. The pallet is now ready for transport.

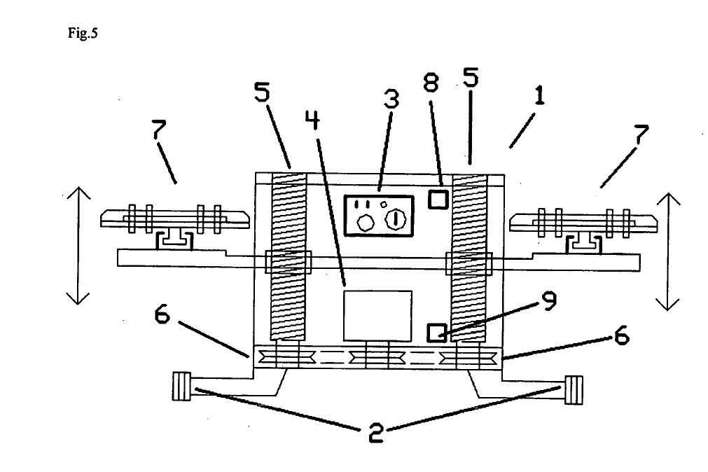

FIG. 5 is a schematic representation of a suitable lift device. Lift (1) consists of a wheeled chassis operatively equipped with a common motor or individual motors to drive the wheels (2), a control system (3) to steer the vehicle and also to control the speed at which it moves and further to control the vertical motion of the lift and the lateral extension of the rail forks. Further, said lift is equipped with a second electric motor (4) operatively connected to two rotating screw posts (5). Connections to said screw posts could be made with belts and pulleys or with gears and a chain (6). Suitable reduction ratios would be selected based on motor speed and power versus the desired speed of lift. As the motor is made to spin under command of the controller, the screw posts rotate, screwing the rail fork arm (7) either up or down, (i.e. lift or lowering the rail forks). An upper limit switch (8) and a lower limit switch (9) strategically placed in the lift would indicate the appropriate maximum and minimum lift heights. FIG. 5 shows the lift in its mid position with the ability to move to both higher and lower positions depending on the rotational direction of the jackscrews. The minimum height of the rail forks (7) is operatively selected by design such that the pallet can be engaged when on the ground and the highest hospital bed or operating table one might reasonably encounter determines the maximum height. It is quite feasible that a more portable lift device can be constructed for use in a mobile situation such as an ambulance or rescue vehicle. Such device providing the same basic service as herein described.

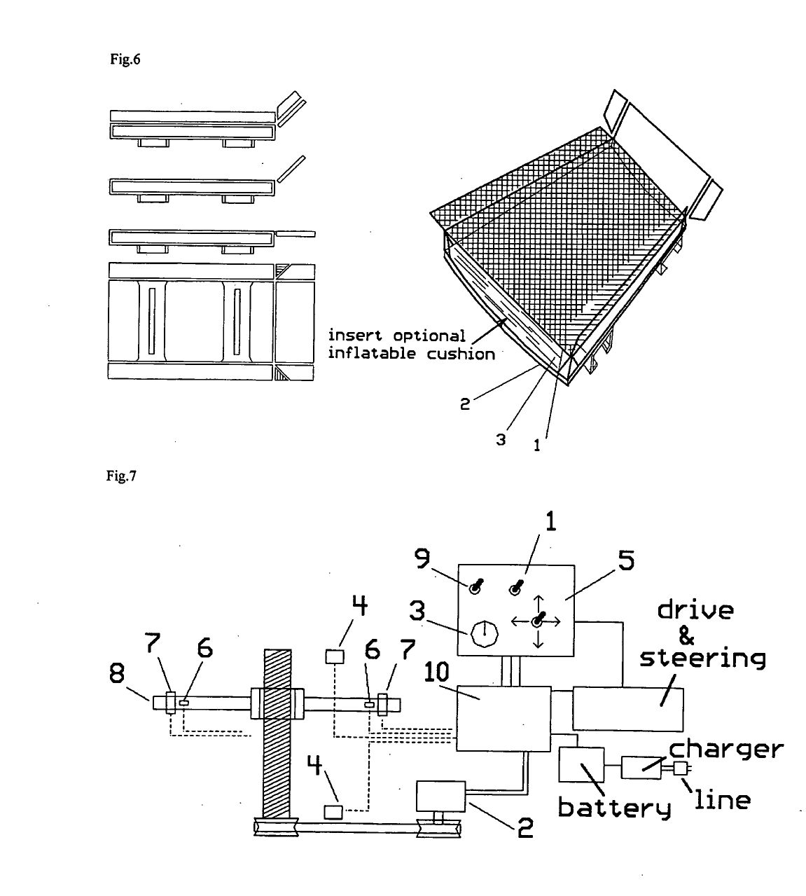

FIG. 6 shows the pallet with its articulated parts. Upper framework (1) is coated with a visco-elastic gel around the metalwork and further fitted with a similar coated material for use as mattress surface. The visco-elastic gel material in the preferred embodiment of this invention is Kemmler SHOCKtec Gel™). This material originated in the medical industry in the mid 1960s, looks like a gel, but is actually a stable solid. This class of materials will not bottom under shock and is extremely comfortable to sit or lay on. Until now, this visco elastic material has been poured into forms and cured. The concept of coating a surface with this material providing both strength and comfort as a bed, is presently thought to be unique. Said pallet is fitted with side and head extensions. The head portion is operatively hinged to coincide with the moveable portion of a standard hospital bed. In other words it can be raised or lowered with the bed. Ratchet or other locking means can be employed to keep the extension in any given position, as it is often more comfortable for a patient to be in an elevated position rather than prone. The locking head would allow a patient to be transported in said elevated position. Further, side extensions are used as side guards when raised, and offer extended bed width when locked in the flat position, a boon for the larger patient. FIG. 6 also shows that the pallet is built in two tiers. The top tier (1) is the upper framework and the above said netting, all of which is welded or otherwise securely fastened to the lower frame (2). The lower frame is envisioned as a solid but relatively lightweight plate to which is attached both the pair of tracks and also the upper frame. The lower framework has no need for a gel coating. A space (3) of approximately 3 inches is provided between the two tiers to allow for the flexing of the above said surface under load. Further, this space is useful to affix sheets or blankets around the patient during cold weather, allowing said sheets and blankets to be added or removed without the necessity of lifting the patient. Further, if needed, an optional air mattress can be inserted and inflated, offering extra support as needed. Insertion and removal of said inflatable mattress can be done totally unimpeded and also without disturbing the patient. The pallet as described can be used as a stand-alone device or it can sit upon a hospital bed with or without a standard mattress. For instance, in a stand-alone situation, the pallet can be fitted with fixed or removable corner legs and act as a stand-alone bed. Said legs could optionally be fitted with wheels and/or be made to be adjustable in height.

FIG. 7 describes a generic control block diagram for the present invention. The primary function of the control system is to provide an operator interface to the lift device. Said interface will allow the operator to:
1. Raise and lower the lift (1).
2. Control the movement of (drive) the lift from place to place (5).
3. Provide an on/off function (9).

Control (1) for up and down movement of the lift is provided. Those skilled in the art will recognize that there are many means to that end. In its simplest form, two switches, (one for UP and another for DOWN) can do the job. The same function can, of course be accomplished with a two pole double throw switch. When activated, lift motor (2) is started and begins turning the jackscrews at a predetermined speed. Variable speed (3) can optionally be provided for. The operator can stop the movement by releasing the switch at any time, thus stopping the pallet at the desired height. Limit switches (4) at either end of the jackscrews prevent over-travel of the lift (8) by either physically removing power for the drive motor or by signaling the motor controller to stop. For safety reasons, redundant safety features are preferred. Preferably, a dual limit sensor at each end would first signal the motor controller to stop. However, if the signal is ignored and the second limit stop is encountered, power would be removed from the drive motor. As for driving and steering the lift, two fundamental controls are provided for. The first is steering. For simplicity, the present embodiment includes means to operatively move each of the 4 drive wheels in unison. Said wheels are operatively connected to a steering wheel or joystick (5) which allows said wheels to simultaneously turn up to 90 degrees, allowing the lift to move either ahead or sideways. Again, anyone skilled in the art will recognize that electrical means in the form of stepper motors and an appropriate controller can be used effectively. Syncro motors, servo motors, servo feedback dc motors, and many other means, too numerous to mention here, are also useable and should be obvious to anyone skilled in the art. Mechanical drives through gears, belts and the like are also obvious. The second function is speed control. This function includes both moving the vehicle in the desired direction and also stopping the vehicle as needed. Simple mechanical methods of drive and steering are preferred, however it is also interesting to provide for a drive motor at each wheel controlled by a common processor and yet another for steering. This embodiment will allow for remote control of the vehicle as the need arises.

During the process of engaging the pallet with the lift rails, latches (7) are employed to lock the pallet firmly to the lift rails. If said latches are of the electrically actuated type, sensors on the lift rail forks (6) are employed which detect and determine when the lift and pallet are correctly engaged. Said sensors feed information back to the controller (10), which in turn engages or disengages the appropriate latch devices (7). If said latches are of the mechanically actuated type, then said sensors are not required.

It should be clear from the foregoing descriptions that many variations on the theme are possible and practical. This application seeks to describe one simple form of the invention for the sake of clarity. It is expressly understood that variations of the implementation of the system can be made without departing from the spirit and scope of the invention.

1. A medical patient lift and transport system comprising:
A. a lift device including at least one lift rail; and
B. a pallet including an upper mattress surface and at least one track positioned in vertically spaced relation to said upper mattress surface and adapted to be securely engaged by a respective one of said at least one lift rail.

2. A system of claim 1 where said lift has a motorized drive

3. A system of claim 1 where said lift has four wheel steering

4. A system of claim 1 where said lift is manually operated

5. A system of claim 1 where said lift is operated using microprocessor based control circuits

6. A system of claim 1 where said pallet is articulated to coincide with a standard hospital bed

7. A system of claim 1 where said pallet can be attached to a second similar pallet to facilitate patient transfer to said second pallet
